(19) United States
(12) Patent Application Publication
(10) Pub. No.: US 2024/0327704 A1
(43) Pub. Date: Oct. 3, 2024

(54) REAGENT FOR DETECTING METHYL SALICYLATE, METHYL SALICYLATE SENSOR, METHOD FOR SENSING METHYL SALICYLATE USING THE SAME AND METHODS FOR DETECTING PLANT PATHOGEN INFECTIONS

(71) Applicant: NEC Corporation, Tokyo (JP)

(72) Inventor: Katsumi MAEDA, Tokyo (JP)

(73) Assignee: NEC Corporation, Tokyo (JP)

(21) Appl. No.: 18/616,357

(22) Filed: Mar. 26, 2024

(30) Foreign Application Priority Data
Mar. 30, 2023 (JP) 2023-054485

(51) Int. Cl. C09K 11/07; G01N 21/01; G01N 21/64; G01N 21/84

(52) U.S. Cl. CPC C09K 11/07; G01N 21/6428; C09K 2211/182; G01N 2021/0181; G01N 2021/6439; G01N 2021/6463; G01N 2021/8466

(57) ABSTRACT

The present invention provides a reagent for detecting methyl salicylate, which is a plant hormone released when a plant is infected with a disease, in the cultivation of plants including agricultural crops, and a method for sensing methyl salicylate using the same, thereby providing a method for detection of pathogen infection in a plant.

A reagent for detecting methyl salicylate, comprising a terbium complex salt having two or more types of counter anions; a methyl salicylate sensor comprising a capture section of methyl salicylate having the reagent and a detection section detecting that methyl salicylate is captured in the capture section; and a method for sensing methyl salicylate using the above reagent to detect methyl salicylate.

This application is based upon and claims the benefit of priority from Japanese patent application No. 2023-54485, filed on Mar. 30, 2023, the disclosure of which is incorporated herein in its entirety by reference.

### TECHNICAL FIELD

The present invention relates to a reagent for detecting methyl salicylate, which is a plant hormone released when plants are infected with pathogens, a methyl salicylate sensor, a method for sensing methyl salicylate using the same, and a method for detection of pathogen infection in a plant.

### BACKGROUND ART

It is known that when a plant is infected with a pathogen, it synthesizes and releases a plant hormone, which is a signal substance, and informs surrounding plants of the pathogen infection, thereby promoting a defense mechanism in advance. By quickly recognizing a signal substance emitted by such plant, it becomes possible to detect pest damage.

As a method for detection of pest damage to a target plant, for example, Patent document 1 describes a method in which a monitor plant having a photoprotein gene is placed in the vicinity of a target plant, and the monitor plant senses volatile substances released by the target plant in response to stress and emits light.

### CITATION LIST

### Patent Literature

Patent Literature 1: International Publication No. WO 2019/082942

### SUMMARY OF INVENTION

### Technical Problem

An object of the present invention is to provide a reagent for detecting methyl salicylate, which is a plant hormone released when a plant is infected with a disease, in the cultivation of plants including agricultural crops, a methyl salicylate sensor, and a method for sensing methyl salicylate using the same, thereby providing a method for detection of pathogen infection in a plant.

### Solution to Problem

The present inventors have made intensive studies to solve the above problems. As a result, by using terbium complex salt as a receptor for methyl salicylate, fluorescence emission from the complex generated upon reaction with methyl salicylate increases, and the pathogen infection in a plant can be detected, and the present invention has been completed.

One aspect of this embodiment relates to a reagent for detecting methyl salicylate, comprising a terbium complex salt having two or more types of counter anions.

Further, one aspect of this embodiment relates to a methyl salicylate sensor that detects methyl salicylate, comprising:
a capture section of methyl salicylate having the reagent; and
a detection section detecting that methyl salicylate has been captured by the capture section.

Moreover, one aspect of this embodiment relates to a method for sensing methyl salicylate, comprising capturing methyl salicylate using the reagent according to claim 1 or 2, comprising:
(i) reacting a terbium complex salt with methyl salicylate to form a complex;
(ii) exposing the complex to excitation light;
(iii) detecting fluorescence emitted by the complex.

Furthermore, one aspect of this embodiment relates to a method for detecting pathogen infection in a plant by placing the reagent in the vicinity of a plant and confirming fluorescence emission derived from a complex formed by reaction between a terbium complex salt and methyl salicylate.

### Advantageous Effect of Invention

According to the present invention, by including a terbium complex salt as a receptor for methyl salicylate in a reagent for detecting methyl salicylate, the intensity of fluorescence emission from the complex formed by the reaction with methyl salicylate, which is a volatile plant hormone released when plants are infected with pathogens, increases, making it possible to detect infection of plants by pathogenic bacteria.

### BRIEF DESCRIPTION OF DRAWINGS

FIG. 1 shows FTIR spectra of terbium complex salt and terbium single salts (terbium acetate and terbium pivalate).

FIG. 2 shows the fluorescence spectrum curves obtained in Example 1 (terbium complex salt+methyl salicylate), Control 1 (terbium complex salt) and Control 2 (methyl salicylate).

FIG. 3 shows fluorescence spectrum curves obtained in Example 6 (terbium complex salt+methyl salicylate), Comparative example 5 (terbium acetate+methyl salicylate) and Comparative example 6 (terbium pivalate+methyl salicylate).

### DESCRIPTION OF EMBODIMENTS

A mode for carrying out the present invention will be described using drawings. However, although the embodiments described below include technically preferable limitations for carrying out the present invention, the scope of the invention is not limited to the following.

### [1] Reagent for Detecting Methyl Salicylate

One embodiment of the present invention is a reagent for detecting methyl salicylate, comprising a terbium complex salt having two or more types of counter anions as a receptor of methyl salicylate. In the present invention, the term “reagent” is defined as a chemical substance used for the detection or quantification of substances by chemical methods, the synthesis of substances or the measurement of physical properties.

### [Receptor of Methyl Salicylate: Terbium Complex Salt]

The terbium complex salt that can be used to recognize methyl salicylate in the present invention is a terbium complex salt that has two or more types of counter anions with different structures.

As the terbium complex salt having two or more types of counter anions, those represented by the following general formula (1) are preferable.

TbXₐY₃₋ₐ (1)

(wherein 0<a<3, X is one monovalent anion selected from the group consisting of RCOO—, halide ions and nitrate ions, Y is one or more monovalent anions selected from the group consisting of RCOO—, halide ions, and nitrate ions; and R is an alkyl group having 1 to 20 carbon atoms, a cycloalkyl group having 3 to 6 carbon atoms, and an aryl group having 6 to 14 carbon atoms, optionally substituted with halogen.)

The number of counter anions may be two or three or more types. When there are two types of counter anions, X and Y are each independently one type of monovalent anion, and when there are three or more types of counter anions, X is one type of monovalent anion, and Y are multiple types of monovalent anions.

Preferably, the counter anions are selected from the group consisting of RCOO—, halide ions and nitrate ions. Here, R is an alkyl group having 1 to 20 carbon atoms, a cycloalkyl group having 3 to 6 carbon atoms, or an aryl group having 6 to 14 carbon atoms, which is optionally substituted with halogen; preferably an alkyl group having 1 to 6 carbon atoms or a phenyl group optionally substituted with a fluorine atom; more preferably methyl group, ethyl group, propyl group, 2-methylpropyl group, trifluoromethyl group, tert-butyl group, or isobutyl group. Examples of halide ions include fluoride ions, chloride ions, bromide ions, and iodide ions, with chloride ions being preferred.

X in the general formula (1) is preferably a pivalate ion (i.e., R-tert-butyl group), and Y in the general formula (1) is preferably one or more monovalent anions selected from the group consisting of acetate ion, trifluoroacetate ion and 2-methylbutyrate ion (i.e., R=methyl group, ethyl group, propyl group, 2-methylpropyl group, trifluoromethyl group, isobutyl group). Further, specific examples of terbium complex salts include, but are not limited to, terbium acetate-terbium pivalate complex salt, terbium 2-methylbutyrate-terbium pivalate complex salt, terbium trifluoroacetate-terbium pivalate complex salt, and terbium acetate-terbium 2-methylbutyrate complex salt.

Terbium complex salt, for example, terbium pivalate-terbium acetate complex salt (Tb(t-C₄H₉COO)ₐ(CH₃COO)₃₋_{ₐ}) can be synthesized by completely dissolving terbium pivalate and terbium acetate in methanol and subjecting them to a heating reaction. Furthermore, the ratio of counterions (X,Y) in the complex salt can be changed by changing the blending ratio of terbium salt during synthesis.

When x is a pivalate ion, a in general formula (1) is preferably 0.3 to 2.5, more preferably 0.4 to 2.0, further preferably 0.5 to 1.5, and particularly preferably 0.7 to 1.0.

Terbium complex salt can selectively recognize methyl salicylate by reacting with methyl salicylate to form a methyl salicylate complex. The generated methyl salicylate-terbium complex emits fluorescence characteristic of terbium complexes when excited with UV light. On the other hand, only the terbium complex salt is irradiated with UV light, the emission intensity of the fluorescence is small, so it is not observed. Moreover, since terbium complex salt does not react with and does not recognize other plant hormones other than methyl salicylate, such as methyl jasmonate, it can selectively recognize methyl salicylate. Terbium complex salt has an increased fluorescence emission intensity from a complex formed by reaction with methyl salicylate, compared to terbium single salt.

### [Non-Volatile Ionic Liquid]

The reagent for detecting methyl salicylate of the present invention can comprise a non-volatile ionic liquid in addition to the terbium complex salt in order to effectively capture methyl salicylate. When an ionic liquid is included in the reagent, the terbium complex salt exists dissolved in the non-volatile ionic liquid, but some of it may be precipitated. The terbium complex salt can similarly function as a receptor for methyl salicylate whether it is dissolved in a nonvolatile ionic liquid or precipitated.

Examples of non-volatile ionic liquids that can be used in the present invention include imidazolium salts, phosphonium salts, pyridinium salts, ammonium salts, piperidinium salts, pyrrolidinium salts. Specific examples include, but are not limited to, at least one selected from the group consisting of 1-ethyl-3-methylimidazolium acetate, 1-butyl-3-methylimidazolium acetate, 1-ethyl-3-methylimidazolium tetrafluoroborate, 1-butyl-1-methylpyrrolidinium bis(fluorosulfonyl)imide, 1-butyl-3-methylimidazolium dibutyl phosphate, tetrabutylammonium acetate, 1-butylpyridinium bis(trifluoromethanesulfonyl)imide, 1-methyl-1-propylpiperidinium bis(fluorosulfonyl)imide, 1-ethyl-3-methylimidazolium bis(trifluoromethanesulfonyl)imide, 1-butyl-3-methylimidazolium dicyanamide.

The weight ratio of the ionic liquid to the terbium complex salt is preferably 2 to 40 times, more preferably 3 to 30 times, particularly preferably 4 to 20 times. If the weight ratio of the ionic liquid to the terbium complex salt is less than 2 times, the effect of improving the methyl salicylate detection sensitivity may not be obtained. If the weight ratio of the ionic liquid to the terbium complex salt exceeds 40 times, it may be difficult for the terbium compound to form a complex with methyl salicylate.

The reagent for detecting methyl salicylate of the present invention may optionally comprise other solvents if the effects of the present invention are not impaired. Examples of solvents that can be used include, but are not limited to, dimethyl sulfoxide, methanol, ethanol, water, N,N-dimethylformamide, tetrahydrofuran, acetone, acetonitrile, and 1,4-dioxane.

### [2] Methyl Salicylate Sensor

One embodiment of the present invention relates to a methyl salicylate sensor for detecting methyl salicylate comprising: a capture section of methyl salicylate having the reagent and a detection section for detecting that methyl salicylate has been captured by the capture section.

### (1) Capture Section

The capture section of methyl salicylate sensor of the present invention has a terbium complex salt, which is a receptor that selectively recognizes methyl salicylate. In addition to the terbium complex salt, the capture section preferably contains a non-volatile ionic liquid in order to effectively trap methyl salicylate. In the capture section, the reagent is preferably contained in the medium.

### [Medium]

The medium containing the terbium complex salt of the present invention may be, includes, but is not limited to, for example, paper or glass fibers, resins (for example, polymethyl methacrylate, polyethylene, polypropylene, polyvinyl chloride, polystyrene, nylon resin, polyamide, polycarbonate, polyethylene terephthalate, polybutylene terephthalate, polyphenylene oxide), water soluble polymers (cellulose, agarose, starch, sodium alginate, acrylic acid-, acrylamide, polyvinyl alcohol, polyethylene oxide, polyvinylpyrrolidone).

For example, when paper is used as a medium, a terbium complex salt is dissolved in a solvent, an ionic liquid may be added thereto, paper (for example, filter paper) is impregnated with the resulting solution, and the solvent is removed by drying at room temperature to 60° C. to obtain a medium containing the terbium complex salt and the non-volatile ionic liquid. The medium can be impregnated with a mixture of a terbium complex salt and a non-volatile ionic liquid without using a solvent. However, the use of a solvent is preferable because it facilitates impregnation of the medium with the terbium complex salt and facilitates adjustment of the concentration of the terbium complex salt. After removing the solvent, the terbium complex salt is dissolved in the non-volatile ionic liquid, but part of it may be precipitated. A terbium complex salt can similarly function as a receptor for methyl salicylate whether dissolved in a non-volatile ionic liquid or precipitated.

A solvent for dissolving the terbium complex salt, dimethyl sulfoxide, methanol, ethanol, water, N,N-dimethylformamide, tetrahydrofuran, acetone, acetonitrile, 1,4-dioxane can be used, but are limited to these.

Also, the ratio of the ionic liquid to the solvent can be appropriately decided depending on the medium to be impregnated. When the ratio of the ionic liquid to the solvent is low, the amount of the ionic liquid in the medium after drying is small, and the effect of improving the detection sensitivity may be small. On the other hand, when the ratio of the ionic liquid to the solvent is high, the ionic liquid has a high viscosity, which may disadvantageously make it difficult to impregnate the medium. Therefore, the ratio of the ionic liquid to the solvent is appropriately decided depending on the medium. For example, when filter paper is impregnated, the ratio of the ionic liquid to the solvent is preferably 5 to 50% by weight, more preferably 10 to 30% by weight.

### (2) Detection Section

The detection section of the methyl salicylate sensor of the present invention is configured to optically detect that methyl salicylate has been captured by the capture section. The detection section may be configured as a separate device instead of being integrated with the capture section. In one aspect of the present invention, the optical detection section has an excitation light source (light-emitting part) and a detecting element (fluorescence-receiving part) in order to detect the fluorescence emission of a complex (methyl salicylate complex) formed by a terbium complex salt and methyl salicylate, detection and/or concentration measurement of methyl salicylate can be performed based on the change in fluorescence intensity observed.

In one aspect of the present invention, the detection section may include a computer executing a program to process the detection and/or concentration measurement of methyl salicylate. Such a program may be, for example, a program that causes a computer to (i) receive a signal from an optical detecting element, (ii) determine the presence or absence and/or the concentration of methyl salicylate by analyzing the received signal, and (iii) output the analysis results.

In one aspect of the present invention, analysis of the received signal may include determining the presence or absence and/or the concentration of methyl salicylate, for example by comparing the received signal to a predetermined reference value. Also, in one aspect of the present invention, analysis results can be output to, for example, a display device connected to the sensor, or other equipment connected via a network.

In one aspect of the present invention, the methyl salicylate sensor of the present invention senses methyl salicylate, which is a plant hormone released when agricultural crops are infected with pathogens. Therefore, the methyl salicylate sensor of the present invention can be used as a sensor for detecting pathogen infection in plants including agricultural crops.

### [3] Method for Sensing Methyl Salicylate

One aspect of the present invention relates to a method for sensing methyl salicylate using fluorescence emission from a complex obtained by reacting a terbium complex salt with methyl salicylate using the reagent or methyl salicylate sensor, wherein the method comprises:
(i) reacting a terbium complex salt with methyl salicylate to form a complex;
(ii) exposing the complex to excitation light;
(iii) detecting fluorescence emitted by the complex.

While the terbium complex salt alone hardly exhibits fluorescence emission, the complex produced by the reaction of the terbium complex salt and methyl salicylate newly exhibits fluorescence emission. Thus, methyl salicylate can be detected by utilizing this phenomenon.

In one aspect of the present invention, a suitable wavelength in the range of 300 to 400 nm is selected as the excitation wavelength. Further, in one aspect of the present invention, the determination of the concentration of methyl salicylate can also be performed by comparing the intensity of the detected fluorescence with a predetermined reference value.

### [4] Method for Detecting Pathogen Infection in a Plant

One aspect of the present invention relates to a method for detecting pathogen infection in plants by placing the reagent or methyl salicylate sensor near the plant and confirming fluorescence emission derived from the complex formed by reaction between a terbium complex salt and methyl salicylate.

Examples of the plant that may be the monitoring target include, but are not limited to, cucumber, watermelon, tomato, eggplant, green pepper, paprika, shishito pepper, melon, Chinese cabbage, cabbage, radish, lettuce, green onion, broccoli, onion, garlic, yam, asparagus, carrot, potato, celery, tobacco, rice, and strawberry.

Examples of the disease that may be detected include, but are not limited to, ring spot disease, leaf spot, Corynespora target spot, leaf mold, fusarium wilt, root rot wilt, Verticillium wilt, brown root rot, gray phytophthora rot, root rot, black dot root rot, southern blight, damping off, brown leaf spot, downy mildew, powdery mildew, gray mold, anthracnose, scab, Sclerotinia rot, gummy stem blight, leaf spot, blight, mosaic disease, spotted wilt, yellow leaf curl, bacterial wilt, bacterial soft rot, bacterial canker, pith necrosis, bacterial black spot, and bacterial leaf spot, and examples of the pathogen infection that may be detected include, but are not limited to, infections caused by the causative microorganisms of the above diseases.

In the context of the present disclosure, when referring to installing in the vicinity of a plant, examples of the term “vicinity” include, but are not limited to, a distance within 2 m, within 1 m, within 75 cm, within 50 cm, within 40 cm, within 30 cm, within 20 cm, within 10 cm, or within 5 cm of the plant to be monitored, and an appropriate distance is selected as appropriate in consideration of a variety of factors. A person skilled in the art would be able to set the position of the sensor to be installed as appropriate in consideration of a variety of conditions.

Further, one embodiment of the present invention relates to the use of a reagent or a methyl salicylate sensor in detection of pathogen infection in a plant. Moreover, one embodiment of the present invention relates to use of a t terbium complex salt in production of a reagent or a methyl salicylate sensor.

### EXAMPLES

Hereinafter, an embodiment of the present invention will be explained in details by using Examples, but the present invention is not limited to these Examples.

### (Synthesis Example 1) Complex Salt of Terbium Acetate (Tb(CH₃COO)₃:TbA) and Terbium Pivalate (Tb(t-C₄H₉COO)₃:TbPv) [Tb(CH₃COO)_{0.75}(C₄H₉COO)_{2.25}:0.25TbA-0.75TbPv]

0.2 g of terbium acetate tetrahydrate and 0.6797 g of terbium pivalate (the molar ratio of TbA and TbPv is 1:3) were heated under reflux for 5 hours in 65 ml of methanol. After cooling, methanol was distilled off, and the precipitated white crystals were vacuum-dried to obtain 0.74 g of the desired complex salt of terbium acetate and terbium pivalate.

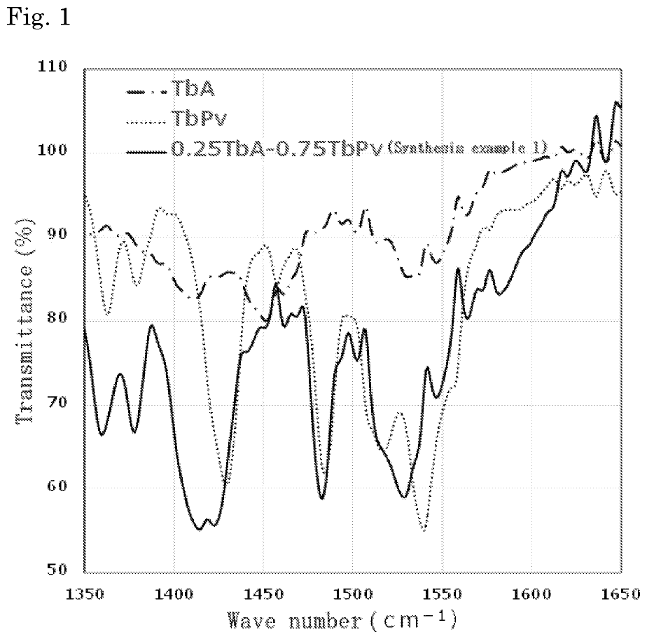

FIG. 1 shows FTIR spectra of the complex salt obtained in Synthesis Example 1 and the single salts (terbium acetate and terbium pivalate). The solid line represents the FTIR spectrum of terbium complex salt (0.25TbA-0.75TbPv), the dotted line represents the FTIR spectrum of terbium pivalate, and the dashed line represents the FTIR spectrum of terbium acetate. The absorption peak at 1429 cm 1 derived from the pivalate ion of terbium pivalate alone was shifted to 1422 cm 1 in the complex salt, confirming that the complex salt was not a mixture of terbium acetate and terbium pivalate.

### (Synthesis Example 2) Complex Salt of Terbium Acetate (TbA) and Terbium Pivalate (TbPv) [Tb(CH₃COO)_{1.5}(t-C₄H₉COO)_{1.5}:0.5TbA-0.5TbPv]

0.3 g of terbium acetate tetrahydrate and 0.3398 g of terbium pivalate (the molar ratio of TbA and TbPv is 1:1) were heated under reflux for 5 hours in 35 ml of methanol. After cooling, methanol was distilled off, and the precipitated white crystals were vacuum-dried to obtain 0.448 g of the desired complex salt of terbium acetate and terbium pivalate.

As a result of measuring FTIR of the complex salt obtained in Synthesis Example 2, the absorption peak at 1429 cm 1 derived from the pivalate ion of terbium pivalate alone was shifted to 1423 cm 1, confirming that the complex salt was not a mixture of terbium acetate and terbium pivalate.

### (Synthesis Example 3) Complex Salt of Terbium Acetate (TbA) and Terbium Pivalate (TbPv) [Tb(CH₃COO)_{0.6}(t-C₄H₉COO)_{2.4}:0.2TbA-0.8TbPv]

0.1545 g of terbium acetate tetrahydrate and 0.7 g of terbium pivalate (the molar ratio of TbA and TbPv is 1:4) were heated under reflux for 5 hours in 70 ml of methanol. After cooling, methanol was distilled off, and the precipitated white crystals were vacuum-dried to obtain 0.75 g of the desired complex salt of terbium acetate and terbium pivalate.

As a result of measuring FTIR of the complex salt obtained in Synthesis Example 3, the absorption peak at 1429 cm 1 derived from the pivalate ion of terbium pivalate alone was shifted to 1422 cm 1, confirming that the complex salt was not a mixture of terbium acetate and terbium pivalate.

### (Synthesis Example 4) Complex Salt of 2-Terbium Methylbutyrate [Tb (2-MBA)] and Terbium Pivalate (TbPv) [Tb(C₂H₅(CH₃)CHCOO)_{0.75}(t-C₄H₉COO)_{2.25}:0.25Tb (2-MBA)-0.75TbPv]

0.227 g of terbium 2-methylbutyrate and 0.6787 g of terbium pivalate (the molar ratio of Tb(2-MBA) to TbPv is 1:3) were heated under reflux for 5 hours in 70 ml of methanol. After cooling, methanol was distilled off, and the precipitated white crystals were dried in vacuum to obtain 0.83 g of the desired complex salt of terbium 2-methylbutyrate and terbium pivalate.

As a result of measuring FTIR of the complex salt obtained in Synthesis Example 4, the absorption peak at 1429 cm⁻¹ derived from the pivalate ion of terbium pivalate alone was shifted to 1424 cm⁻¹, confirming that the complex salt was not a mixture of terbium acetate and terbium pivalate.

### (Synthesis Example 5) Complex Salt of Terbium Trifluoroacetate (TbTfa) and Terbium Pivalate (TbPv) [Tb(CF₃COO)_{0.75}(t-C₄H₉COO)_{2.25}:0.25TbTfa-0.75TbPv]

0.239 g of terbium trifluoroacetate trihydrate and 0.6 g of terbium pivalate (the molar ratio of TbTfa and TbPv is 1:3) were heated under reflux for 5 hours in 60 ml of methanol. After cooling, methanol was distilled off, and the precipitated white crystals were dried in vacuum to obtain 0.749 g of the desired complex salt of terbium trifluoroacetate and terbium pivalate.

As a result of measuring FTIR of the complex salt obtained in Synthesis Example 5, the absorption peak at 1429 cm 1 derived from the pivalate ion of terbium pivalate alone was shifted to 1427 cm 1, confirming that the complex salt was not a mixture of terbium acetate and terbium pivalate.

[Fluorescence Behavior Associated with Reaction with Methyl Salicylate (MSA) (Reagent)]

### Example 1: (0.25TbA-0.75TbPv)+MSA

0.9 ml of a DMSO solution of the complex salt of terbium acetate (TbA) and terbium pivalate (TbPv) (0.25TbA-0.75TbPv) obtained in Synthesis Example 1 (the concentration 1.73 mM) and 0.1 ml of a DMSO solution of methyl salicylate (MSA) (the concentration 1.5 mM) were mixed, diluted 20 times after 10 minutes, the solution was placed in a quartz cell, and the fluorescence spectrum was measured at an excitation wavelength of 365 nm.

### Example 2: (0.5TbA-0.5TbPv)+MSA

0.9 ml of a DMSO solution of the complex salt of terbium acetate (TbA) and terbium pivalate (TbPv) (0.5TbA-0.5TbPv) obtained in Synthesis Example 2 (the concentration 1.73 mM) and 0.1 ml of a DMSO solution of methyl salicylate (MSA) (the concentration 1.5 mM) were mixed, diluted 20 times after 10 minutes, the solution was placed in a quartz cell, and the fluorescence spectrum was measured at an excitation wavelength of 365 nm.

### Example 3: (0.2TbA-0.8TbPv)+MSA

0.9 ml of a DMSO solution of the complex salt of terbium acetate (TbA) and terbium pivalate (TbPv) (0.2TbA-0.8TbPv) obtained in Synthesis Example 3 (the concentration 1.73 mM) and 0.1 ml of a DMSO solution of methyl salicylate (MSA) (the concentration 1.5 mM) were mixed, diluted 20 times after 10 minutes, the solution was placed in a quartz cell, and the fluorescence spectrum was measured at an excitation wavelength of 365 nm.

### Comparative Example 1: TbA+MSA

0.9 ml of a DMSO solution of terbium acetate tetrahydrate (TbA) (the concentration 1.73 mM) and 0.1 ml of a DMSO solution of methyl salicylate (MSA) (the concentration 1.5 mM) were mixed, diluted 20 times after 10 minutes, the solution was placed in a quartz cell, and the fluorescence spectrum was measured at an excitation wavelength of 365 nm.

### Comparative Example 2: TbPv+MSA

0.9 ml of a DMSO solution of terbium pivalate (TbPv) (the concentration 1.73 mM) and 0.1 ml of a DMSO solution of methyl salicylate (MSA) (the concentration 1.5 mM) were mixed, diluted 20 times after 10 minutes, the solution was placed in a quartz cell, and the fluorescence spectrum was measured at an excitation wavelength of 365 nm.

### Control 1: 0.25TbA-0.75TbPv Only

0.9 ml of a DMSO solution of the complex salt of terbium acetate (TbA) and terbium pivalate (TbPv) (0.25TbA-0.75TbPv) obtained in Synthesis Example 1 (the concentration 1.73 mM) and 0.1 ml of a DMSO were mixed, diluted 20 times, the solution was placed in a quartz cell, and the fluorescence spectrum was measured at an excitation wavelength of 365 nm.

### Control 2: MSA Only

0.1 ml of a DMSO solution of methyl salicylate (MSA) (the concentration 1.5 mM) and 0.9 ml of a DMSO were mixed, diluted 20 times, the solution was placed in a quartz cell, and the fluorescence spectrum was measured at an excitation wavelength of 365 nm.

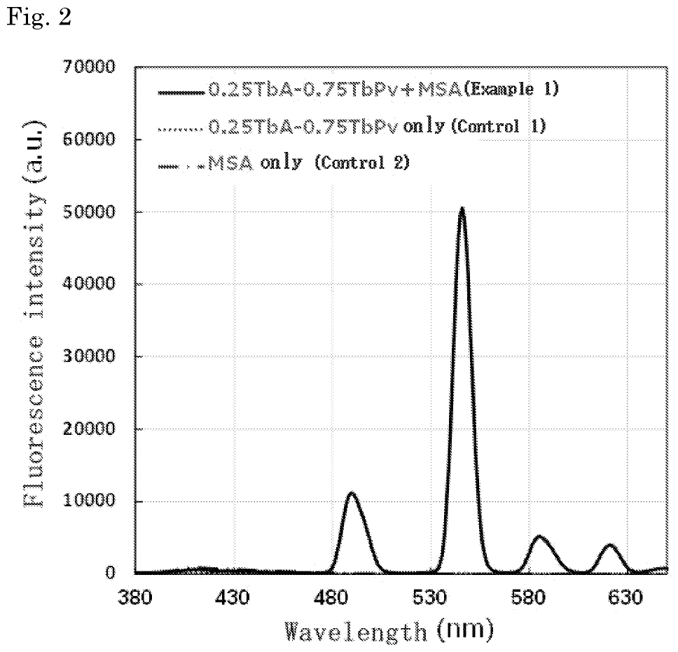

FIG. 2 shows the fluorescence spectrum curves obtained in Example 1, Control 1 and Control 2. The solid line represents the fluorescence spectrum of terbium complex salt (0.25TbA-0.75TbPv)+MSA, the dotted line represents the fluorescence spectrum of terbium complex salt (0.25TbA-0.75TbPv) only, and the dashed line represents the fluorescence spectrum of MSA only. From this result, it was found that terbium complex salt and MSA do not emit fluorescence by themselves in the range of 480 to 630 nm, but fluorescence emission (maximum wavelength 546 nm) was exhibited by the reaction between the terbium complex salt and MSA.

In the fluorescence spectrum obtained in Examples 1 to 3, Comparative example 1 and Comparative example 2, the fluorescence intensity at a wavelength of 546 nm was summarized in Table 1. From these results, it was found that the fluorescence intensity of the complex salts (Examples 1 to 3) increased compared to those of single salts such as terbium acetate (Comparative example 1) and terbium pivalate (Comparative example 2).

TABLE 1

| | | Fluorescence intensity |
|---|---|---|
| | | at wavelength 546 nm |
| | | (relative intensity) |
| Examples 1 | Complex salt obtained in | 50580 (1.15) |
| | Synthesis example 1 | |
| | (0.25TbA-0.75TbPv) + MSA | |
| Examples 2 | Complex salt obtained in | 49248 (1.12) |
| | Synthesis example 2 | |
| | (0.25TbA-0.76TbPv) + MSA | |
| Examples 3 | Complex salt obtained in | 46293 (1.05) |
| | Synthesis example 3 | |
| | (0.25TbA-0.77TbPv) + MSA | |
| Comparative | terbium acetate (TbA) + MSA | 20121 (0.46) |
| example 1 | | |
| Comparative | terbium bivalate (TbPv) + MSA | 44150 (1.00) |
| example 2 | | |

### Example 4: (0.25Tb (2-MBA)-0.75TbPv)+MSA

0.9 ml of a DMSO solution of the complex salt of 2-terbium methylbutyrate (Tb (2-MBA)) and terbium pivalate (TbPv) (0.25Tb (2-MBA)-0.75TbPv) obtained in Synthesis Example 4 (the concentration 1.73 mM) and 0.1 ml of a DMSO solution of methyl salicylate (MSA) (the concentration 1.5 mM) were mixed, diluted 20 times after 10 minutes, the solution was placed in a quartz cell, and the fluorescence spectrum was measured at an excitation wavelength of 365 nm.

### Comparative Example 3: Tb (2-MBA)+MSA

0.9 ml of a DMSO solution of 2-terbium methylbutyrate (Tb (2-MBA)) (the concentration 1.73 mM) and 0.1 ml of a DMSO solution of methyl salicylate (MSA) (the concentration 1.5 mM) were mixed, diluted 20 times after 10 minutes, the solution was placed in a quartz cell, and the fluorescence spectrum was measured at an excitation wavelength of 365 nm.

In the fluorescence spectrum obtained in Example 4, Comparative example 2 and Comparative example 3, the fluorescence intensity at the wavelength of 546 nm was summarized in Table 2. From these results, it was found that the fluorescence intensity of the complex salt (Example 4) increased compared to those of single salts such as terbium pivalate (Comparative example 2) and 2-terbium methylbutyrate

### Comparative Example 3

TABLE 2

| | | Fluorescence intensity |
|---|---|---|
| | | at wavelength 546 nm |
| | | (relative intensity) |
| Examples 4 | Complex salt obtained in | 49105 (1.11) |
| | Synthesis example 4 | |
| | (0.25Tb(2-MBA)-0.75TbPv) + | |
| | MSA | |
| Comparative | terbium bivalate (TbPv) + | 44150 (1.00) |
| example 2 | MSA | |
| Comparative | 2-terbium methylbutyrate | 31379 (0.71) |
| example 3 | (Tb(2-MBA)) + MSA | |

### Example 5: (0.25TbTfa-0.75TbPv)+MSA

0.9 ml of a DMSO solution of the complex salt of terbium trifluoroacetate (TbTfa) and terbium pivalate (TbPv) (0.25TbTfa-0.75TbPv) obtained in Synthesis Example 5 (the concentration 1.73 mM) and 0.1 ml of a DMSO solution of methyl salicylate (MSA) (the concentration 1.5 mM) were mixed, diluted 20 times after 10 minutes, the solution was placed in a quartz cell, and the fluorescence spectrum was measured at an excitation wavelength of 365 nm.

### Comparative Example 4: TbTfa+MSA

0.9 ml of a DMSO solution of terbium trifluoroacetate (TbTfa) (the concentration 1.73 mM) and 0.1 ml of a DMSO solution of methyl salicylate (MSA) (the concentration 1.5 mM) were mixed, diluted 20 times after 10 minutes, the solution was placed in a quartz cell, and the fluorescence spectrum was measured at an excitation wavelength of 365 nm.

In the fluorescence spectrum obtained in Example 5, Comparative example 2 and Comparative example 4, the fluorescence intensity at the wavelength of 546 nm was summarized in Table 3. From these results, it was found that the fluorescence intensity of the complex salt (Example 5) increased compared to those of single salts such as terbium pivalate (Comparative example 2) and terbium trifluoroacetate (Comparative example 4).

TABLE 3

| | | Fluorescence intensity |
|---|---|---|
| | | at wavelength 546 nm |
| | | (relative intensity) |
| Examples 5 | Complex salt obtained in | 45909 (1.04) |
| | Synthesis example 5 | |
| | (0.25TbTfa-0.75TbPv) + MSA | |
| Comparative | terbium bivalate (TbPv) + MSA | 44150 (1.00) |
| example 2 | | |
| Comparative | terbium trifluoroacetate | 31259 (0.71) |
| example 4 | (TbTfa) + MSA | |

[Fluorescence Behavior Due to Reaction with Methyl Salicylate (MSA) (Sensor)] (Example 6: (0.25TbA-0.75TbPv)+MSA)

0.2 ml of a DMSO solution of the terbium acetate-terbium pivalate complex salt (0.25TbA-0.75TbPv) obtained in Synthesis Example 1 (the concentration 50 mM) was dropped onto a circular filter paper (Φ40 mm) and dried to volatilize the DMSO to obtain a filter paper containing 0.25TbA-0.75TbPv. The obtained filter paper was placed in a desiccator with a capacity of 800 ml, and methyl salicylate at a concentration of 7.5 ppb was introduced into the desiccator using nitrogen as a carrier gas. After exposure for 1 hour, the filter paper was taken out and the fluorescence spectrum was measured.

### Comparative Example 5: TbA+MSA

0.2 ml of a DMSO solution of terbium acetate tetrahydrate (TbA) (the concentration 50 mM) was dropped onto a circular filter paper (Φ40 mm) and dried to volatilize the DMSO to obtain a filter paper containing TbA. The obtained filter paper was placed in a desiccator with a capacity of 800 ml, and methyl salicylate at a concentration of 7.5 ppb was introduced into the desiccator using nitrogen as a carrier gas. After exposure for 1 hour, the filter paper was taken out and the fluorescence spectrum was measured.

### Comparative Example 6: TbPv+MSA

0.2 ml of a DMSO solution of terbium pivalate (TbPv) (the concentration 50 mM) was dropped onto a circular filter paper (Φ40 mm) and dried to volatilize the DMSO to obtain a filter paper containing TbPv. The obtained filter paper was placed in a desiccator with a capacity of 800 ml, and methyl salicylate at a concentration of 7.5 ppb was introduced into the desiccator using nitrogen as a carrier gas. After exposure for 1 hour, the filter paper was taken out and the fluorescence spectrum was measured.

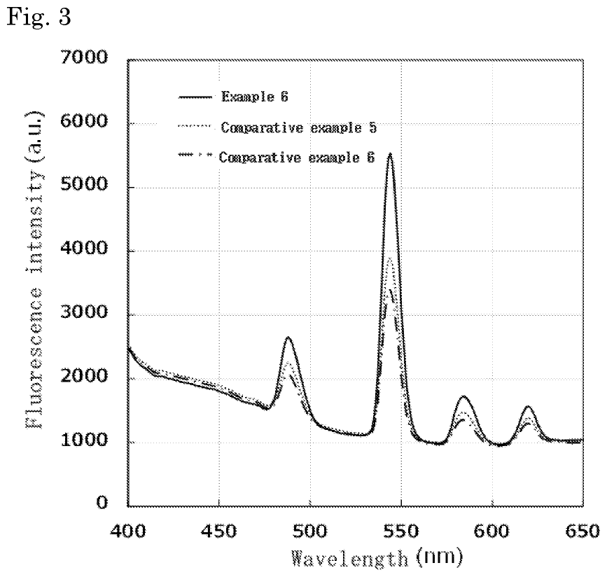

FIG. 3 shows the fluorescence spectrum curves obtained in Example 6, Comparative example 5 and Comparative example 6. The solid line represents the fluorescence spectrum of terbium complex salt (0.25TbA-0.75TbPv), the dotted line represents the fluorescence spectrum of TbA, and the dashed line represents the fluorescence spectrum of TbPv. From the fluorescence spectrum after 1 hour exposure shown in FIG. 3, it was confirmed that terbium acetate-terbium pivalate complex salt (0.25TbA-0.75TbPv) had a stronger fluorescence intensity than terbium acetate or terbium pivalate. From this result, it was found that the sensor containing terbium acetate-terbium pivalate complex salt (0.25TbA-0.75TbPv) could sense methyl salicylate at a concentration of 7.5 ppb with high sensitivity.

### (Example 7: (0.25TbA-0.75TbPv)+MSA) (Using Ionic Liquid)

0.0449 g of terbium acetate-terbium pivalate complex salt (0.25TbA-0.75TbPv) obtained in Synthesis Example 1 was dissolved in 1.6 ml of dimethyl sulfoxide (DMSO), 0.4 ml of 1-ethyl-1-methylimidazolium acetate (EMImAc) was added therein as an ionic liquid (DMSO/EMImAc=8/2), 0.2 ml of the solution was dropped onto a circular filter paper (Φ40 mm) and dried to volatilize DMSO to obtain a filter paper containing 0.25TbA-0.75TbPv and EMImAc. The obtained filter paper was placed in a desiccator with a capacity of 800 ml, and methyl salicylate at a concentration of 7.5 ppb was introduced into the desiccator using nitrogen as a carrier gas. After exposure for 1 hour, the filter paper was taken out and the fluorescence spectrum was measured.

As shown in Table 4, the fluorescence intensity at a wavelength of 546 nm in the fluorescence spectrum obtained in Example 6 was 5535. On the other hand, the fluorescence intensity at a wavelength of 546 nm in the fluorescence spectrum obtained in Example 7 was 18422, and it was found that the inclusion of the ionic liquid increased the fluorescence emission intensity about three times. These results revealed that the sensitivity of methyl salicylate was improved by including the ionic liquid together with the complex salt.

TABLE 4

| | | Fluorescence intensity |
|---|---|---|
| | | at wavelength 546 nm |
| | | (relative intensity) |
| Examples 6 | Complex salt of | 50580 (1.15) |
| | Synthesis example 1 | |
| Examples 7 | Complex salt of | 49248 (1.12) |
| | Synthesis example 1 + | |
| | 20% EMImAc | |

### Example 8: (0.5TbA-0.5TbPv)+MSA

0.0417 g of terbium acetate-terbium pivalate complex salt (0.5TbA-0.5TbPv) obtained in Synthesis Example 2 was dissolved in 2 ml of dimethyl sulfoxide (DMSO), 0.2 ml of the solution was dropped onto a circular filter paper (Φ40 mm) and dried to volatilize DMSO to obtain a filter paper containing 0.5TbA-0.5TbPv. The obtained filter paper was placed in a desiccator with a capacity of 800 ml, and methyl salicylate at a concentration of 7.5 ppb was introduced into the desiccator using nitrogen as a carrier gas. After exposure for 1 hour, the filter paper was taken out and the fluorescence spectrum was measured.

### Example 9: (0.5TbA-0.5TbPv)+MSA) (Using Ionic Liquid

0.0417 g of terbium acetate-terbium pivalate complex salt (0.5TbA-0.5TbPv) obtained in Synthesis Example 2 was dissolved in 1.6 ml of dimethyl sulfoxide (DMSO), 0.4 ml of 1-ethyl-1-methylimidazolium acetate (EMImAc) was added therein as an ionic liquid (DMSO/EMImAc=8/2), 0.2 ml of the solution was dropped onto a circular filter paper (Φ40 mm) and dried to volatilize DMSO to obtain a filter paper containing 0.5TbA-0.5TbPv and EMImAc. The obtained filter paper was placed in a desiccator with a capacity of 800 ml, and methyl salicylate at a concentration of 7.5 ppb was introduced into the desiccator using nitrogen as a carrier gas. After exposure for 1 hour, the filter paper was taken out and the fluorescence spectrum at the exciting wavelength of 365 nm was measured.

As shown in Table 5, the fluorescence intensity at a wavelength of 546 nm in the fluorescence spectrum obtained in Example 8 was 6862. On the other hand, the fluorescence intensity at a wavelength of 546 nm in the fluorescence spectrum obtained in Example 9 was 12848. It was found that the inclusion of the ionic liquid increased the fluorescence emission intensity about two times. These results revealed that the sensitivity of methyl salicylate was improved by including the ionic liquid together with the complex salt.

TABLE 5

| | | Fluorescence intensity |
|---|---|---|
| | | after 1 hour exposure |
| | | to 7.5 ppb-MSA |
| Examples 8 | Complex salt of | 6862 |
| | Synthesis example 2 | |
| Examples 9 | Complex salt of | 12848 |
| | Synthesis example 2 + | |
| | 20% EMImAc | |

### INDUSTRIAL APPLICABILITY

The reagent and the methyl salicylate sensor for detecting methyl salicylate, which is a plant hormone of the present invention, can selectively detect methyl salicylate, which is a plant hormone released by plants during pathogen infection, because it efficiently captures methyl salicylate, forms a complex, and emits fluorescence by containing a terbium complex salt or a combination of a terbium complex salt and a non-volatile ionic liquid. In addition, pathogen infection in a plant can be detected by using the reagent or the methyl salicylate sensor. Specifically, the reagent or the methyl salicylate sensor can be used as a new sensor for agricultural ICT in facility horticulture such as greenhouses, which can detect pathogen infection of agricultural crops.

Although the present invention has been described with reference to the embodiments and Examples, the present invention is not limited to the above embodiments and Examples. Various modifications can be made to the configuration and details of the present invention within the scope of the present invention that can be understood by those skilled in the art.

### Supplementary Note 1

A reagent for detecting methyl salicylate, comprising a terbium complex salt having two or more types of counter anions.

### Supplementary Note 2

The reagent according to supplementary note 1, wherein the terbium complex salt is represented by the following general formula (1):

TbXₐY₃₋ₐ (1)

(wherein 0<a<3, X is one monovalent anion selected from the group consisting of RCOO—, halide ions and nitrate ions, Y is one or more monovalent anions selected from the group consisting of RCOO—, halide ions, and nitrate ions; and R is an alkyl group having 1 to 20 carbon atoms, a cycloalkyl group having 3 to 6 carbon atoms, and an aryl group having 6 to 14 carbon atoms, optionally substituted with halogen.)

### Supplementary Note 3

The reagent according to supplementary note 2, wherein X in the general formula (1) is pivalate ion.

### Supplementary Note 4

The reagent according to supplementary note 2, wherein Y in the general formula (1) is one or more monovalent anions selected from the group consisting of acetate ion, trifluoroacetate ion, and 2-methylbutyrate ion.

### Supplementary Note 5

The reagent according to any one of preceding supplementary notes, further comprising non-volatile ionic liquid.

### Supplementary Note 6

The reagent according to supplementary note 5, wherein the ionic liquid is at least one selected from the group consisting of imidazolium salts, phosphonium salts, pyridinium salts, ammonium salts, piperidinium salts, and pyrrolidinium salts.

### Supplementary Note 7

The reagent according to supplementary note 5 or 6, wherein the ionic liquid is at least one selected from the group consisting of 1-ethyl-3-methylimidazolium acetate, 1-butyl-3-methylimidazolium acetate, 1-ethyl-3-methylimidazolium tetrafluoroborate, 1-butyl-1-methylpyrrolidinium bis(fluorosulfonyl)imide, 1-butylpyridinium bis(trifluoromethanesulfonyl)imide, 1-methyl-1-propylpiperidinium bis(fluorosulfonyl)imide, 1-ethyl-3-methylimidazolium bis(trifluoromethanesulfonyl)imide and methyl 1-butyl-3-methylimidazolium dicyanamide.

### Supplementary Note 8

The reagent according to any one of supplementary notes 5 to 7, wherein the ratio of the ionic liquid to the terbium complex salt is 2 to 40 times by weight.

### Supplementary Note 9

A methyl salicylate sensor that detects methyl salicylate, comprising:
a capture section of methyl salicylate having the reagent according to any one of preceding supplementary notes; and
a detection section detecting that methyl salicylate has been captured by the capture section.

### Supplementary Note 10

The methyl salicylate sensor according to supplementary note 9, wherein the capture section comprises a medium containing the reagent.

### Supplementary Note 11

The methyl salicylate sensor according to supplementary note 10, the medium is paper, glass fiber, resin, or water-soluble polymer.

### Supplementary Note 12

The methyl salicylate sensor according to any one of supplementary notes 9 to 11, wherein
the detection section comprises an optical detection element and a computer, and has program that causes a computer to:
(i) receive a signal from an optical detecting element,
(ii) determine the presence or absence and/or the concentration of methyl salicylate by analyzing the received signal, and
(iii) output the analysis results.

### Supplementary Note 13

A method for preparing the methyl salicylate sensor according to any one of supplementary notes 9 to 12, comprising obtaining a capture section of methyl salicylate having a medium containing the terbium complex salt and the ionic liquid by:
dissolving the terbium complex salt in a solvent and adding an ionic liquid to form a solution,
containing the resulting solution in the medium, and then
removing the solvent by drying.

### Supplementary Note 14

The method for preparing the methyl salicylate sensor according to supplementary note 13, the ratio of the ionic liquid to the solvent is 5 to 50% by weight.

### Supplementary Note 15

A method for sensing methyl salicylate, comprising detecting methyl salicylate using the reagent according to any one of supplementary notes 1 to 8, comprising:
(i) reacting a terbium complex salt with methyl salicylate to form a complex;
(ii) exposing the complex to excitation light;
(iii) detecting fluorescence emitted by the complex.

### Supplementary Note 16

A method for sensing methyl salicylate, comprising detecting methyl salicylate using the methyl salicylate sensor according to any one of supplementary notes 9 to 12, comprising:
(i) reacting a terbium complex salt with methyl salicylate to form a complex;
(ii) exposing the complex to excitation light;
(iii) detecting fluorescence emitted by the complex.

### Supplementary Note 17

The method according to supplementary note 15 or 16, using a wavelength within the range of 300 to 400 nm as the excitation wavelength of the excitation light.

### Supplementary Note 18

The method according to any one of supplementary notes 15 to 17, further comprising determining the concentration of methyl salicylate by comparing the intensity of the detected fluorescence with a predetermined reference value.

### Supplementary Note 19

A method for detecting pathogen infection in a plant by placing the reagent according to any one of supplementary notes 1 to 8 in the vicinity of a plant and confirming fluorescence emission derived from a complex formed by reaction between a terbium complex salt and methyl salicylate.

### Supplementary Note 20

A method for detecting pathogen infection in a plant by placing the methyl salicylate sensor according to any one of supplementary notes 9 to 12 in the vicinity of a plant and confirming fluorescence emission derived from a complex formed by reaction between a terbium complex salt and methyl salicylate.

1. A reagent for detecting methyl salicylate, comprising a terbium complex salt having two or more types of counter anions.

2. The reagent according to claim 1, wherein the terbium complex salt is represented by the following general formula (1):
TbXₐY₃₋ₐ (1)
(wherein 0<a<3, X is one monovalent anion selected from the group consisting of RCOO—, halide ions and nitrate ions, Y is one or more monovalent anions selected from the group consisting of RCOO—, halide ions, and nitrate ions; and R is an alkyl group having 1 to 20 carbon atoms, a cycloalkyl group having 3 to 6 carbon atoms, and an aryl group having 6 to 14 carbon atoms, optionally substituted with halogen.)

3. The reagent according to claim 2, wherein X in the general formula (1) is pivalate ion.

4. The reagent according to claim 2, wherein Y in the general formula (1) is one or more monovalent anions selected from the group consisting of acetate ion, trifluoroacetate ion, and 2-methylbutyrate ion.

5. The reagent according to claim 1, further comprising non-volatile ionic liquid.

6. The reagent according to claim 5, wherein the ionic liquid is at least one selected from the group consisting of imidazolium salts, phosphonium salts, pyridinium salts, ammonium salts, piperidinium salts, and pyrrolidinium salts.

7. The reagent according to claim 5, wherein the ionic liquid is at least one selected from the group consisting of 1-ethyl-3-methylimidazolium acetate, 1-butyl-3-methylimidazolium acetate, 1-ethyl-3-methylimidazolium tetrafluoroborate, 1-butyl-1-methylpyrrolidinium bis(fluorosulfonyl)imide, 1-butylpyridinium bis(trifluoromethanesulfonyl)imide, 1-methyl-1-propylpiperidinium bis(fluorosulfonyl)imide, 1-ethyl-3-methylimidazolium bis(trifluoromethanesulfonyl)imide and methyl 1-butyl-3-methylimidazolium dicyanamide.

8. The reagent according to claim 5, wherein the ratio of the ionic liquid to the terbium complex salt is 2 to 40 times by weight.

9. A methyl salicylate sensor that detects methyl salicylate, comprising:
a capture section of methyl salicylate having the reagent according to claim 1; and
a detection section detecting that methyl salicylate has been captured by the capture section.

10. The methyl salicylate sensor according to claim 9, wherein the capture section comprises a medium containing the reagent.

11. The methyl salicylate sensor according to claim 10, the medium is paper, glass fiber, resin, or water-soluble polymer.

12. The methyl salicylate sensor according to claim 9, wherein
the detection section comprises an optical detection element and a computer, and has program that causes a computer to:
(i) receive a signal from an optical detecting element,
(ii) determine the presence or absence and/or the concentration of methyl salicylate by analyzing the received signal, and
(iii) output the analysis results.

13. A method for preparing the methyl salicylate sensor according to claim 9, comprising obtaining a capture section of methyl salicylate having a medium containing the terbium complex salt and the ionic liquid by:
dissolving the terbium complex salt in a solvent and adding an ionic liquid to form a solution,
containing the resulting solution in the medium, and then
removing the solvent by drying.

14. The method for preparing the methyl salicylate sensor according to claim 13, the ratio of the ionic liquid to the solvent is 5 to 50% by weight.

15. A method for sensing methyl salicylate, comprising capturing methyl salicylate using the reagent according to claim 1, comprising:
(i) reacting a terbium complex salt with methyl salicylate to form a complex;
(ii) exposing the complex to excitation light;
(iii) detecting fluorescence emitted by the complex.

16. A method for sensing methyl salicylate, comprising detecting methyl salicylate using the methyl salicylate sensor according to claim 9, comprising:
(i) reacting a terbium complex salt with methyl salicylate to form a complex;
(ii) exposing the complex to excitation light;
(iii) detecting fluorescence emitted by the complex.

17. The method according to claim 15, using a wavelength within the range of 300 to 400 nm as the excitation wavelength of the excitation light.

18. The method according to claim 15, further comprising determining the concentration of methyl salicylate by comparing the intensity of the detected fluorescence with a predetermined reference value.

19. A method for detecting pathogen infection in a plant by placing the reagent according to claim 1 in the vicinity of a plant and confirming fluorescence emission derived from a complex formed by reaction between a terbium complex salt and methyl salicylate.

20. A method for detecting pathogen infection in a plant by placing the methyl salicylate sensor according to claim 9 in the vicinity of a plant and confirming fluorescence emission derived from a complex formed by reaction between a terbium complex salt and methyl salicylate.
